(19) United States
(12) Patent Application Publication
(10) Pub. No.: US 2011/0186242 A1
(43) Pub. Date: Aug. 4, 2011

(54) Safety Mechanism for a Window Covering

(75) Inventors: Patrick Foley, Winston-Salem, NC (US); Martin Richard Van Buren, Atlanta, GA (US)

(73) Assignee: NEWELL WINDOW FURNISHINGS, INC., High Point, NC (US)

(21) Appl. No.: 12/976,000

(22) Filed: Dec. 22, 2010

Related U.S. Application Data
(60) Provisional application No. 61/289,548, filed on Dec. 23, 2009.

(51) Int. Cl. F16G 11/10; A47H 23/00; A47H 5/02; B23P 11/00

(52) U.S. Cl. 160/193; 160/340; 29/428

(57) ABSTRACT

A safety device for a window covering comprises a head rail and a shade panel extending from the head rail. A lift cord extends along one side of the shade panel between the head rail and the bottom of the shade panel. A safety cord extends between the head rail and the bottom edge of the shade panel where the safety cord comprises a plurality of loops. The lift cord extends through the plurality of loops. The safety cord is connected to the shade panel at fixed points between the top edge and the bottom edge to limit the distance the safety cord may be moved away from the shade panel. A safety device may also comprise a safety ribbon that is attached to the shade panel by a hook and loop connector that covers the lift cord.

This application claims benefit of priority under 35 U.S.C. §119(e) to the filing date of to U.S. Provisional Application No. 61/289,548, as filed on Dec. 23, 2009, which is incorporated herein by reference in its entirety.

The safety device described herein is suitable for use with Roman shades although it may have use on a variety of window coverings.

### BACKGROUND OF THE INVENTION

Window coverings such as shades and blinds are known that use pull cords to raise and lower and otherwise manipulate the shade panel. The pull cords may be exposed where they may present an entanglement hazard. One such window covering is commonly referred to as a Roman shade. A typical Roman shade comprises a head rail from which a flexible shade panel is suspended. The shade panel may be divided into a plurality of panels that are connected to one another at horizontal joints or seams. A plurality of lift cords may be provided that have a first end that can be manipulated by a user to raise or lower the shade panel. The lift cords extend to the head rail and down the back of the shade panel where the second ends of the cords are connected to the bottom edge of the shade panel or to a bottom rail that is connected to the bottom edge of the shade panel. The cords may pass through eyelets or rings that are positioned at the joints or seams. The lift cords may be pulled to raise the shade panel and released to lower the shade panel.

### SUMMARY OF THE INVENTION

A safety device for a window covering comprises a head rail and a shade panel extending from the head rail where the shade panel has a top edge and a bottom edge. A lift cord extends between the head rail and the bottom of the shade panel for raising the shade panel. A safety cord extends between the head rail and the bottom edge of the shade panel where the safety cord comprises a plurality of loops. The lift cord extends through the plurality of loops. The safety cord is connected to the shade panel at fixed points between the top edge and the bottom edge to limit the distance the safety cord may be moved away from the shade panel.

The shade panel may be divided into a plurality of panels connected to one another at a plurality of horizontal joints. The lift cord may extend along the head rail and form a pull cord. The lift cord may pass through a plurality of rings where one of the plurality of rings is positioned at each one of the plurality of joints. Each of the plurality of rings may be attached to the shade panel. The safety cord may be attached to each of the plurality of rings. The safety cord may be attached to the head rail or to the top edge of the shade panel. The safety cord may be attached to a bottom rail or the bottom edge of the shade panel. The plurality of loops may be spaced from one another approximately 1 inch or less. The length of the safety cord between adjacent ones of the fixed points may be approximately equal to the distance between the adjacent ones of the fixed points. If a force is exerted by a person or article on the safety cord, the safety cord is prevented from extending away from the shade panel more than the length of the safety cord between adjacent ones of the fixed points.

A safety device for a window covering comprises a head rail and a shade panel extending from the head rail where the shade panel has a top edge and a bottom edge. A lift cord extends between the head rail and the bottom of the shade panel for raising the shade panel. A safety ribbon is attached to the shade panel by a hook and loop connector where the safety ribbon covers the lift cord such that the lift cord is trapped between the safety ribbon and the shade panel.

A method of making a safety device for a window covering comprises providing a head rail; suspending a shade panel from the head rail where the shade panel has a top edge and a bottom edge; extending a safety cord between the head rail and the bottom edge of the shade panel, the safety cord comprising a plurality of loops; extending a lift cord between the head rail and the bottom of the shade panel through the plurality of loops where the lift cord is used to raise and lower the shade panel; attaching the safety cord to the shade panel at a plurality of points between the top edge and the bottom edge to limit the distance the safety cord may be moved away from the shade panel.

The method may comprise attaching the safety cord to a plurality of rings that are attached to the shade panel. The method may also comprise making the shade panel of a plurality of panels joined at a plurality of seams and locating the rings on the plurality of seams. The method may further comprise spacing each loop of the plurality of loops approximately one inch or less from an adjacent loop of the plurality of loops.

### BRIEF DESCRIPTION OF THE DRAWINGS

FIG. 1 is a back view of a window covering and an embodiment of the safety mechanism of the invention.

FIG. 2 is a more detailed back view illustrating the safety mechanism of FIG. 1.

FIGS. 3 and 4 illustrate the operation of the safety mechanism of FIG. 1.

FIG. 5 is a back view of a window covering and another embodiment of the safety mechanism of the invention.

FIG. 6 is a block diagram illustrating a method of making a window covering.

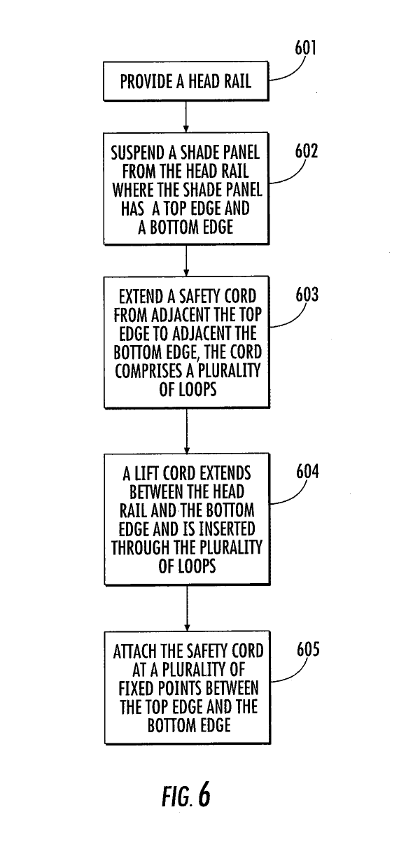

### DETAILED DESCRIPTION OF PREFERRED EMBODIMENTS OF THE INVENTION

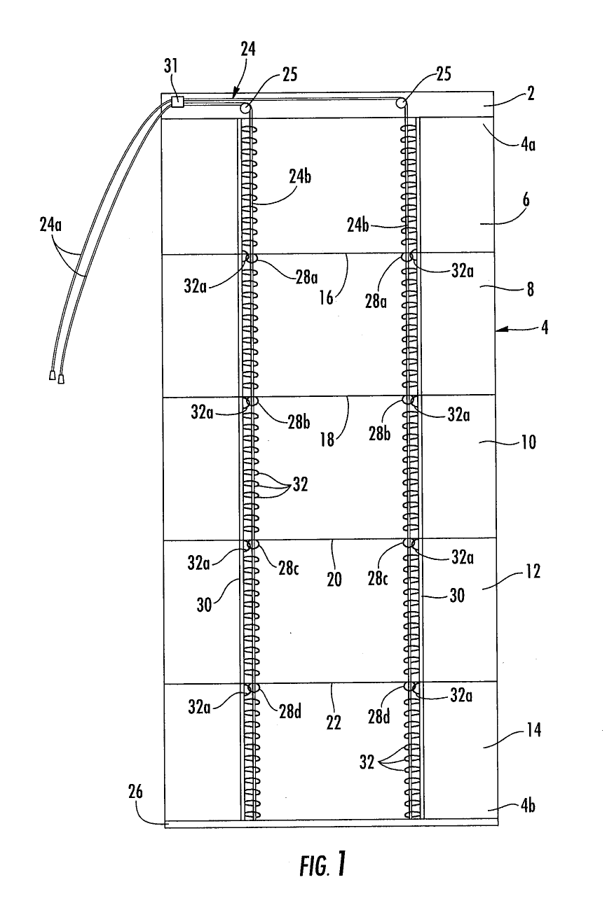

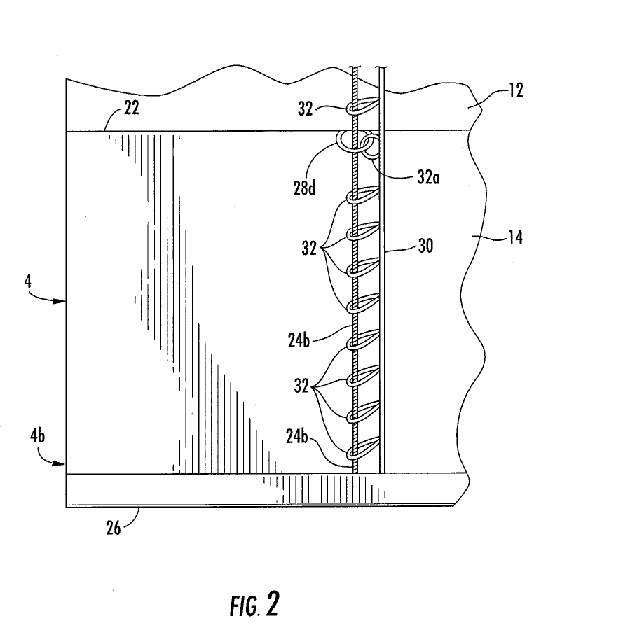

The safety mechanism of the invention may be used on window coverings having exposed lift cords. One such window covering with which the safety mechanism has particular applicability is known as a Roman shade. An example embodiment of a Roman shade is shown in FIGS. 1 and 2. A typical Roman shade comprises a head rail 2 from which a flexible shade 4 is suspended. The head rail 2 may be constructed of wood, steel or other rigid material and may be solid or have an interior channel. The head rail 2 may be mounted to a window or other architectural feature by brackets or other mounting mechanism. The flexible shade panel 4 has a top edge 4a that is located adjacent to and may be connected to head rail 2 and a bottom edge 4b that is suspended remotely from the head rail 2.

The flexible shade panel 4 may be made from a wide variety of suitable materials and designs such as woven or non-woven fabric, natural materials such as wood, bamboo, faux wood or the like. The shade panel 4 is divided into a plurality of panels 6, 8, 10, 12 and 14 connected to one another at a horizontal joints or seams 16, 18, 20 and 22. The joints or seams may be formed by sewn seams connects the adjacent panels, fold lines, separate metal or plastic elements or the like.

A plurality of lift cords 24 are provided that have a first exposed portion 24a that form exposed pull cords that may be manipulated by the user to raise or lower the shade panel 4. The lift cords 24 extend to the head rail 2 and down the back of the shade panel 4 and are connected to the bottom edge 4b of the shade panel 4 or to a bottom rail 26 to form lift cord portions 24b. In the illustrated embodiment the pull cord portions 24a and the lift cord portions 24b are formed of a single cord; however, these elements may be made of different elements that are operatively connected to one another. The lift cords 24 may extend through the hollow interior of the head rail 2 or along the back side of the head rail 2 where they are hidden from view from the front of the window covering. The lift cords 24 may also be guided and controlled along the head rail 2 by other cord control mechanisms 25 such as pulleys, drums, guides or the like. The lift cords 24 pass through eyelets or rings 28a, 28b, 28c and 28d that are positioned at the joints 16, 18, 20 and 22, respectively. A fewer or greater number of panels, joints and rings may be provided. In some shade designs the rings 28a-28d comprise metal or plastic loops that are sewn to the shade. In other designs where a metal or plastic extrusion forms the joints 16, 18, 20 and 22 and the rings 28a-28d may snap or slide into engagement with the metal extrusion.

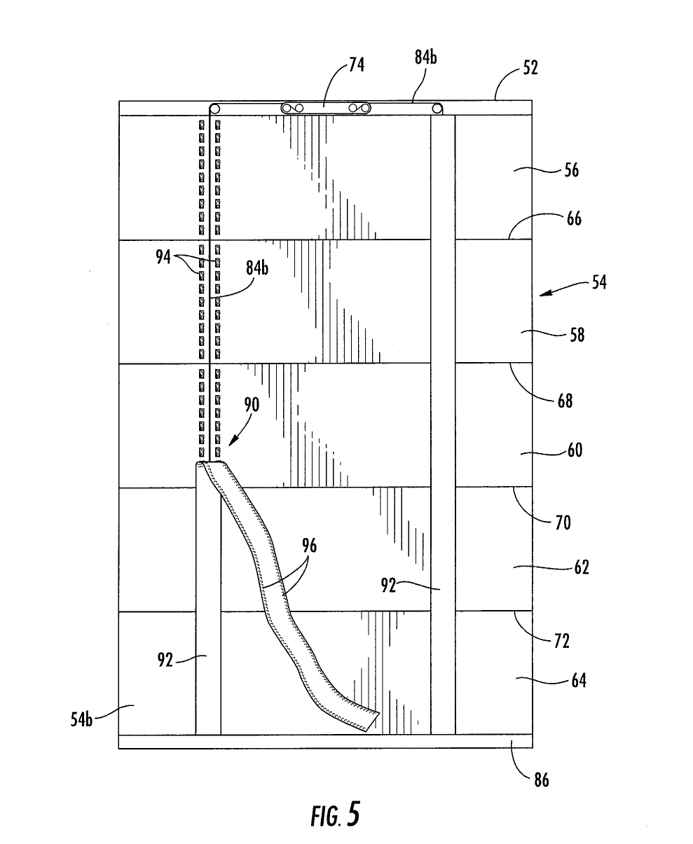

When a user pulls on the pull cord portions 24a of the lift cords 24, the lift cord portions 24b raise the bottom edge 4b of the shade panel and bottom rail 26. The bottom edge 4b of the shade 4 rises until it contacts the first set of rings 28d disposed at the first joint 22. At this point the first panel 14, between the bottom edge 4b of the shade panel 4 and the first joint 22, is folded. As the lift cords 24 are raised further the bottom edge 4b of the shade panel 4, because of its contact with the first set of rings 28d disposed along joint 22, raises the first joint 22 until the bottom of the second panel 12 engages the second set of rings 28c disposed along the second joint 20. At this point the first panel 14 and second panel 12 are both raised and are both folded. The first panel 14 is folded between the bottom edge 4b of the panel and the first joint 22 and the second panel is folded between the first joint 22 and the second joint 20. This process may continue until the shade panel 4 is completely raised and all of the panels 6, 8, 10, 12 and 14 are folded. A cord lock 31 may be provided to hold the lift cords 24 to maintain the shade panel 4 in any raised position. The lift cords 24 may also be tied off to a cleat to hold the shade panel 4 in a raised position. Further, a lift motor such as a spring motor may be located in the head rail for holding the shade 4 in a raised position where the lift cord portions 24b are connected to the spring motor and the pull cord portions 24a are eliminated, as shown in FIG. 5. The lift cords 24 may be released such that the bottom edge 4b of the shade panel 4 is lowered and the panels 6, 8, 10, 12 and 14 are unfolded. The shade panel 4 may assume and be held in any position between the fully raised and lowered positions.

The lift cords 24 are exposed on the back side of the shade panel 4 such that a person or article may become entangled in or caught on the lift cord portions 24b. Because each cord 24 passes through a series of rings 28a-28d, a person or article may become entangled or trapped in any loop created by the cord 24, shade panel 4 and the rings 28.

To minimize the chances that a person or article may become entangled in the lift cord portions 24b, a safety mechanism that comprises a safety cord 30 that runs parallel to each lift cord portion 24b is provided. The safety cord 30 extends from adjacent the head rail 2 to adjacent the bottom edge 4b of the shade panel 4. One end of the safety cord 30 is fixed to the head rail 2 or the top 4a of shade panel 4 and the opposite end of the safety cord 30 is fixed to the bottom rail 26 or the bottom 4b of shade panel 4. The safety cord 30 comprises a cord, ribbon or the like having a series of loops 32 provided along the length thereof. The loops 32 are relatively closely spaced—approximately one inch between adjacent loops 32. One loop 32a is connected to each of the rings 28a-28d such that the safety cord 30 is fixed in position relative to the shade panel 4. The points where the safety cord 30 is fixed in position, either by attachment to rings 28a-28d, the bottom edge 4b or top edge 4a of the shade panel, or the head rail 2 or bottom rail 26, are referred to herein as fixed points. The safety cord 30 has a length and the loops 32 are positioned such that the safety cord 30 just spans the distance between adjacent rings the fixed points with minimum clearance when the shade panel 4 is in the fully extended or lowered position. In other words the length of the safety cord 30 between any two adjacent fixed points is substantially equal to the distance between the fixed points when the shade panel is fully extended. Each lift cord portion 24b extends through the loops 32 such that the lift cord 24 may move relative to the safety cord 30 when the shade is raised and lowered.

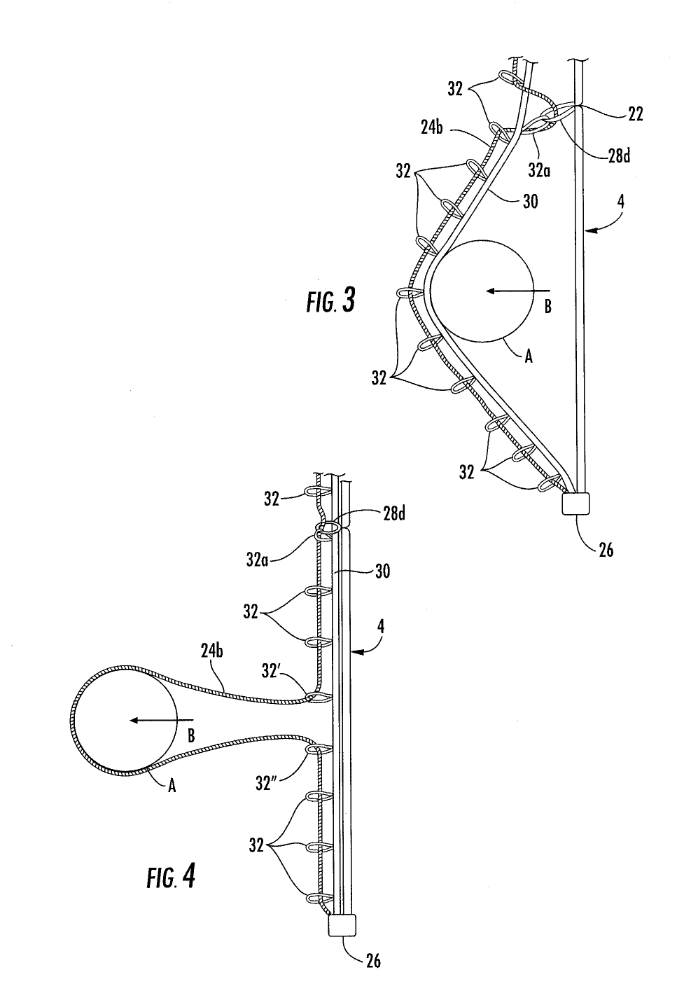

FIG. 3 shows the window covering when a force B is exerted by a person or article A on the lift cord portions 24b and safety cord 30 tending to pull the lift cord and safety cord away from the shade panel 4. The safety cord 30 prevents the lift cord from being extended away from the shade panel in the direction of arrow B beyond a limited distance as limited by the length of the safety cord 30 between the two adjacent fixed points (as shown, the fixed points are the bottom rail 26 and ring 28d). The safety cord 30 limits the space between the lift cord/safety cord and the shade panel 4 to an acceptably safe distance. This space can be made smaller by making the distance between the fixed points shorter as desired. This situation is also true if a force is applied only to the safety cord 30.

FIG. 4 shows the window covering when a force is exerted only on the lift cord portions 24b (and not on safety cord 30) by a person or article A tending to pull the lift cord away from shade panel 4. The lift cord portions 24b may be pulled from between two adjacent loops 32′ and 32″ in the direction of arrow B as shown. However, because the adjacent loops 32′ and 32″ are spaced closely together, the portion of the lift cord 24 that is pulled through the safety cord is constrained to have a very narrow profile D. The distance D between the portions of the lift cord that are pulled from the safety cord is acceptably small such that risk of accidental entanglement inside of the loop created by lift cord 24 is minimized. Further, the close spacing between the adjacent loops 32 makes access to the lift cord 24 difficult such that it is practically difficult for the situation illustrated in FIG. 4 to accidentally occur. The distance between adjacent loops 32 can be shortened to less than 1 inch to make the distance D even narrower if desired.

In an alternative embodiment the loops 32 may be plastic or metal rings connected to safety cord 30 rather than loops formed as part of the cord to reduce friction between the loops 32 and the lift cord portions 24b. The safety cord 30 may also be a fabric tape or a band of fabric rather than a cord. The term “safety cord” as used herein means any flexible elongated member having a plurality of closely spaced loops attached along the length thereof including cord, ribbon, fabric bands or the like having either integrally formed loops or attached rings. The safety cord loops 32 may be made smaller than the attachment loops 32a. This is different than hobble cords that are used to set the length or look of the shade because the safety cord 30 is used as a safety device. The loops 32 may be cord or metal/plastic ring and the attachment loops 32a may be specially designed to incorporate attachment mechanisms to attach directly to the face fabric of shade panel 4 or to extrusions forming seams 16, 18, 20 and 22 (rather than to rings 28a-28d) and may, for example, be insert molded. The safety cords 30 may be made where the attachment loops 32a feature a built in release device to allow larger panel widths (i.e. larger distances between adjacent seams).

An alternate embodiment of a safety mechanism is shown in FIG. 5. The window covering comprises a head rail 52 supporting a flexible shade panel 54 that is divided into a plurality of panels 56, 58, 60, 62 and 64 connected to one another at a horizontal joints or seams 66, 68, 70 and 72 as previously described. The joints or seams may be formed by sewn seams between adjacent panels, fold lines, separate metal or plastic hinge elements or the like. A lift motor 74 such as a spring motor is located on the head rail 52 for holding the shade 54 in a raised position where the lift cord portions 84b are connected from the spring motor to the bottom rail 86 or to the bottom edge 54b of shade panel 54. Alternatively the shade panel may be raised and lowered using the pull cords 24a as described with reference to FIG. 1.

Hook and loop connectors 90 hold a safety ribbon 92 to the face fabric of the shade panel 54 to cover the lift cords 84b. A line of hooks or loops 94 is provided on the shade panel 54 extending along each side of the lift cord portions 84b. On the safety ribbon 92 two lines of mating hooks or loops 96 are arranged to connect to the hook or loops 94 such that the lift cord portions 84b are trapped between the safety ribbon 92 and shade panel 54 when the hook and loop connectors 90 are attached such that the lift cords 84b are isolated from the user. The high shear strength of the hook and loop connectors 90 makes it difficult for the ribbons 92 to be pulled from the face fabric of the shade panel 54 to prevent unwanted access to the lift cords 84b. The low peel strength of the hook and loop connectors 90 allows the weight of the fabric to pull the shade panel 54 free from the safety ribbons 92 when the lift cords 84b are pulled or retracted and the shade panel 54 is raised. When the shade panel 54 is lowered the safety ribbon 92 is reattached to the shade panel 54 using the hook and loop connectors 90 to re-cover the lift cords 84b.

A method of making a safety device for a window covering comprises providing a head rail as previously described (block 601). A shade panel is suspended from the head rail where the shade panel has a top edge and a bottom edge (block 602). A safety cord is extended from adjacent to the top edge of the shade panel to adjacent the bottom edge of the shade panel where the safety cord comprises a plurality of closely spaced loops (block 603). A lift cord is extended between the head rail and the bottom of the shade panel and is inserted through the plurality of loops (block 604). The lift cord is used to raise and lower the shade panel. The safety cord is attached to the shade panel at a plurality of fixed points between the top edge and the bottom edge to limit the distance the safety cord may be moved away from the shade panel (block 605). As previously described the safety cord may be attached at the seams and may be attached to the rings through which the lift cords pass.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. A safety device for a window covering comprising:
a head rail;
a shade panel extending from the head rail, the shade panel having a top edge and a bottom edge;
a lift cord extending between the head rail and the bottom edge of the shade panel for raising the shade panel;
a safety cord extending from adjacent to the head rail to adjacent to the bottom edge of the shade panel, the safety cord comprising a plurality of loops where the lift cord extends through the plurality of loops, the safety cord being connected to the shade panel at a plurality of points between the top edge and the bottom edge to limit the distance the safety cord may be moved away from the shade panel.

2. The safety device for a window covering of claim 1 where the shade panel is divided into a plurality of panels connected to one another at a plurality of horizontal joints.

3. The safety device for a window covering of claim 2 where the lift cord passes through a plurality of rings where one of the plurality of rings is positioned at each one of the plurality of joints.

4. The safety device for a window covering of claim 3 where each of the plurality of rings is attached to the shade panel.

5. The safety device for a window covering of claim 3 where the safety cord is attached to each of the plurality of rings.

6. The safety device for a window covering of claim 1 wherein the length of the safety cord between adjacent ones of the plurality of points is approximately equal to the distance between the adjacent ones of the points.

7. The safety device for a window covering of claim 6 wherein if a force is exerted by a person or article on the safety cord, the safety cord is prevented from extending away from the shade panel more than the length of the safety cord between adjacent ones of the points.

8. The safety device for a window covering of claim 1 where one end of the lift cord is connected to a spring motor.

9. The safety device for a window covering of claim 1 where the lift cord extends along the head rail and forms a pull cord.

10. The safety device for a window covering of claim 1 where the safety cord is attached to the head rail

11. The safety device for a window covering of claim 1 where the safety cord is attached to the top edge of the shade panel.

12. The safety device for a window covering of claim 1 further comprising a bottom rail attached to the shade panel where the safety cord is attached to the a bottom rail.

13. The safety device for a window covering of claim 1 where the safety cord is attached to the bottom edge of the shade panel.

14. The safety device for a window covering of claim 1 wherein the plurality of loops are spaced from one another approximately 1 inch.

15. The safety device for a window covering of claim 1 wherein the plurality of loops are spaced from one another less than 1 inch.

16. A safety device for a window covering comprising:
a head rail;
a shade panel extending from the head rail, the shade panel having a top edge and a bottom edge;
a lift cord extending from adjacent to the head rail to adjacent to the bottom of the shade panel for raising the shade panel;
a safety ribbon attached to the shade panel by a hook and loop connector, said safety ribbon covering the lift cord such that the lift cord is trapped between the safety ribbon and the shade panel.

17. A method of making a safety device for a window covering comprising:
providing a head rail;
suspending a shade panel from the head rail where the shade panel has a top edge and a bottom edge;
extending a safety cord extending from adjacent to the head rail to adjacent to the bottom edge of the shade panel, the safety cord comprising a plurality of loops;
extending a lift cord between the head rail and the bottom edge of the shade panel through the plurality of loops, said lift cord being used to raise and lower the shade panel;
attaching the safety cord to the shade panel at a plurality of points between the top edge and the bottom edge to limit the distance the safety cord may be moved away from the shade panel.

18. The method of claim 17 comprising attaching the safety cord to the plurality of rings and attaching the plurality of rings to the shade panel.

19. The method of claim 18 further comprising making the shade panel of a plurality of panels joined at a plurality of seams and locating one of the plurality of rings on each of said plurality of seams.

20. The method of claim 17 further comprising spacing each loop of the plurality of loops approximately one inch or less from an adjacent loop of the plurality of loops.
